(19) United States
(12) Patent Application Publication
(10) Pub. No.: US 2009/0189853 A1
(43) Pub. Date: Jul. 30, 2009

(54) CHARACTER INPUT DEVICE

(76) Inventor: Eui-Jin OH, Jung-gu (KR)

Correspondence Address: KNOBBE MARTENS OLSON & BEAR LLP, 2040 MAIN STREET, FOURTEENTH FLOOR, IRVINE, CA, 92614, US

(21) Appl. No.: 12/358,161

(22) Filed: Jan. 22, 2009

Related U.S. Application Data
(63) Continuation of application No. PCT/KR2007/003612, filed on Jul. 26, 2007.

(30) Foreign Application Priority Data
Jul. 26, 2006 (KR) 10-2006-0070073
May 14, 2007 (KR) 10-2007-0046336

(51) Int. Cl. G09G 5/00

(52) U.S. Cl. 345/156

(57) ABSTRACT

A character input device is disclosed. In one embodiment, the device includes i) a base including an input region, ii) two input units disposed in the input region, wherein each of the input units is disposed to perform direction inputs of more than two steps that selects any one of a plurality of direction instruction locations that are radially spaced apart from each other from each of reference locations within the input region in each of the direction instruction locations, iii) a direction input detecting unit detecting whether the direction inputs and a multiple input are performed and iv) a controller discriminating and inputting a first character that is redundantly allocated at the corresponding direction instruction location according to the direction instruction location in which the direction inputs are performed and whether the multiple input is performed. The character input device having the construction described above includes two sets of input units that input more than one phoneme at an operation, thereby doubling input quantity and simultaneously inputting a character quickly and accurately.

### RELATED APPLICATIONS

This application is a continuation application, and claims the benefit under 35 U.S.C. §§ 120 and 365 of PCT Application No. PCT/KR2007/003612, filed on Jul. 26, 2007, which is hereby incorporated by reference.

This application also relates to U.S. patent application (Attorney Docket Number: KUMK1.001C1 which is a continuation of PCT Application No. PCT/KR2007/003611) entitled “Character input device and its method,” concurrently filed as this application, which is incorporated by reference.

### BACKGROUND OF THE INVENTION

1. Field of the Invention

The present invention relates to a character input device, and more particularly, to a character input device that comprises two sets of input units capable of inputting more than one phoneme at an operation, thereby doubling input capacity and promptly and accurately inputting a character at the same time.

2. Description of the Related Technology

As software and semiconductor technologies and information processing technology have recently been developed, information devices are tending toward miniaturization. Therefore, in various information devices, the importance of the character input has gradually been increased.

### SUMMARY OF CERTAIN INVENTIVE ASPECTS

One aspect of the present invention is a character input device that comprises two sets of input units capable of inputting more than one phoneme an operation and each performs direction inputs at a multistage manner, thereby doubling input capacity and promptly and accurately inputting a character at the same time.

Another aspect of the invention is a character input device that includes: a base including an input region; two input units disposed in the input region, wherein each of the input units is disposed to perform direction inputs of more than two steps that selects any one of a plurality of direction instruction locations that are radially spaced apart from each other from each of reference locations within the input region in each of the direction instruction locations; a direction input detecting unit detecting whether the direction inputs and a multiple input are performed; and a controller discriminating and inputting a first character that is redundantly allocated at the corresponding direction instruction location according to the direction instruction location in which the direction inputs are performed and whether the multiple input is performed.

The direction inputs may be performed by the input unit by selecting any one of pressing units disposed to correspond to each of the direction instruction locations, and are discriminated to be multiple steps according to pressing distances or pressing strength of the pressing units.

The direction inputs may be performed when the input unit inclines to any one of the direction instruction locations, and are discriminated to be multiple steps according to an inclination angle.

The direction inputs may be performed when the input unit inclines and moves to any one of the direction instruction locations, and are discriminated to be multiple steps according to an angle of an inclined movement.

The direction inputs may be performed when the input unit slides to any one of the direction instruction locations, and are discriminated to be multiple steps according to a sliding distance.

A vowel character may be input to any one of the direction inputs of multiple steps.

The character input device may further comprise a center input key disposed in the center of the input unit, wherein a center input is performed by a pressing operation.

The center input may be performed as a multiple step input of more than two steps according to a pressing distance of the center input key.

A center combination input can be performed in which the center input and the direction inputs are simultaneously made, wherein, when the center combination input is performed, the controller extracts and inputs third data allocated in each of the direction instruction locations from a memory unit.

A touch detecting unit that detects proximity or contact of a finger is disposed in one or more of the upper end of the input unit, the center input key and the pressing units corresponding to the direction instruction locations, thereby allowing a touch input in addition to the direction input and the center input.

The controller discriminates when a touch detection signal by a touch of the finger to the center input key and a direction input detection signal by the pressing of the pressing units are simultaneously received, and when only the direction input detection signal is received, and inputs a different character.

The character input device may further comprise a display unit disposed in one side of the based and displaying an input command extracted by the controller, wherein a keyboard display unit that displays a character allocated to each of the direction instruction locations is disposed in the display unit.

The character input device may further comprise a character display unit disposed in any one of the base and the input unit corresponding to each of the direction instructions locations and displaying a character allocated in the direction inputs or the center combination input in each direction instruction location, wherein when a plurality of character sets are disposed in each direction instruction location, the character display unit displays a character input set that is selected according to a user's input operation.

The direction inputs that are performed in the two input units have different types.

Another aspect of the invention is a character input device that includes: a base including an input region; two input sets disposed in the input region; and a controller, wherein each of the input sets comprises an input unit that performs direction inputs of more than two steps that slide to any one of a plurality of direction instruction locations that are radially spaced apart from each other from a reference location within the input region in view of the reference location according to a sliding distance; a center input key disposed in the center of the input unit and performing a center input by the pressing; a direction input detecting unit detecting direction inputs; and a center input detecting unit that detects the center input, wherein the controller extracts and inputs first characters that are redundantly allocated at the corresponding direction instruction location and the center input key based on the detection result of the direction input detecting unit and the center input detecting unit.

Another aspect of the invention is a character input device that includes: a base including an input region; two input sets disposed in the input region; and a controller, wherein each of the input sets comprises an input unit that performs direction inputs of more than two steps that incline and move to any one of a plurality of direction instruction locations that are radially spaced apart from each other from a reference location within the input region in view of the reference location according to an angle of an inclined movement; a center input key disposed in the center of the input unit and performing a center input by the pressing; a direction input detecting unit detecting direction inputs; and a center input detecting unit that detects the center input, wherein the controller extracts and inputs first characters that are redundantly allocated at the corresponding direction instruction location and the center input key based on the detection result of the direction input detecting unit and the center input detecting unit.

Here, a center combination input can be performed in which the center input and the direction inputs are simultaneously made, wherein, when the center combination input is performed, the controller extracts and inputs a second character that is redundantly allocated in each of the direction instruction locations from a memory unit.

Another aspect of the invention is a character input device that includes: a base including an input region; two input sets disposed in the input region; and a controller, wherein each of the input sets comprises an input unit that is disposed to perform direction inputs of more than two steps that selects any one of pressing units corresponding to direction instruction locations that are radially spaced apart from each other according to a pressing distance of the pressing units; and a direction input detecting unit detecting the direction inputs, wherein the controller extracts and inputs a first character that is allocated in each direction instruction location from a memory unit based on the detection result of the direction input detecting unit.

Another aspect of the invention is a character input device that includes a base including an input region; two input sets disposed in the input region; and a controller, wherein each of the input sets comprises an input unit that is disposed to perform direction inputs of more than two steps that incline to any one of a plurality of direction instruction locations that are radially spaced apart from each other from a reference location in view of the reference location within the input region according to an inclination angle; and a direction input detecting unit detecting the direction inputs, wherein the controller extracts and inputs a first character that is allocated in each direction instruction location from a memory unit based on the detection result of the direction input detecting unit.

Here, the character input device may further comprise a center input key disposed in the center of the input unit, wherein a center input is performed by a pressing operation; and a center input detecting unit detecting the center input.

A center combination input can be performed in which the center input and the direction inputs are simultaneously made, wherein, when the center combination input is performed, the controller extracts and inputs a second character that is redundantly allocated in each of the direction instruction locations from a memory unit.

Another aspect of the invention is a character input device that includes a base including an input region; a first input set comprises a first input unit performing a first direction input of more than two steps that slides to any on of a plurality of first direction instructions locations that are radially spaced apart from each other from a first reference location within the input region according to a sliding distance; and a first direction input detecting unit detecting the first direction input; a second input set comprises a second input unit performing a second direction input of more than two steps that selects any on of pressing units disposed to correspond to a plurality of second direction instructions locations that are radially spaced apart from each other from a second reference location within the input region according to a pressing distance or pressing strength of the pressing units; and a second direction input detecting unit detecting the second direction input; and a controller extracting and inputting characters that are allocated to the first and second direction instruction locations based on the detection results of the first and second direction input detecting units.

### BRIEF DESCRIPTION OF THE DRAWINGS

FIG. 1 is a perspective view of a terminal in which a character input device is mounted according to an embodiment of the present invention.

FIG. 2 is a block diagram of a character input device according to an embodiment of the present invention.

FIG. 3 illustrates various examples of direction inputs according to an embodiment of the present invention.

FIG. 4 illustrates various examples of an input unit for realizing a multistage input with regard to direction inputs according to an embodiment of the present invention.

FIG. 5 is a conceptual diagram for explaining direction inputs, a center input, and a center combination input according to an embodiment of the present invention.

FIG. 6 is an enlarge view of an input unit according to an embodiment of the present invention.

FIG. 7 is a cross-sectional view of an input unit that performs an input operation according to an embodiment of the present invention.

### DETAILED DESCRIPTION OF CERTAIN INVENTIVE EMBODIMENTS

Current information devices have many problems in inputting various characters or commands.

For example, since an input device, such as a keyboard used in a personal computer (PC) or a notebook, is restrictive in reducing its size, it is difficult to miniaturize the information devices.

Moreover, since a touch screen mode used in a personal data assistant (PDA) or a keypad mode used in a cellular phone is slow in input speed or makes inaccurate input, it causes a lot of inconvenience.

To input characters, numbers or symbols in the information devices, such as the aforementioned PC, notebook, PDA or cellular phone, at faster speed, it is necessary to perform one-time operation one phoneme input that one phoneme (character) is input through the one-time input operation.

To input the Korean alphabet (HanGeul) by one-time operation one phoneme input, buttons or input keys to input more than twenty-four characters should be arranged on an information device.

When the language to be input is English, Japanese or another foreign language, it may need much more buttons or input keys than those for HanGeul.

As a portable terminal gradually realizes the performance of a desktop PC, the portable terminal needs to perform all input functions of the keyboard including various command keys (enter key, space key, shift key and others), Function key, symbols and so on, in addition to the function of inputting characters.

However, a current input device used in various information devices is a manner assigning characters to each input key and inputting them by beating or pressing the input keys using fingers.

Accordingly, in a portable personal information terminal such as the cellular phone in which a space arranged with the input keys is relatively narrow, it is difficult to arrange more than twenty-four input keys in finger size. This is a reason that it was difficult to miniaturize the keyboard up to now.

Particularly, in the case of the cellular phone, since more than twenty-four HanGeul characters are to be input using generally twelve buttons, it overlappedly arranges a number of characters on one button.

Therefore, it is necessary to repeatedly press one button two or three times, in order to input one character (phoneme). Consequently, an input time is longer and typographical errors frequently occur.

Moreover, since a method of inputting characters is very complicated, it takes a long time for a user to easily use the method.

To solve the aforementioned problems, as for the HanGeul character input, there has been suggested a method of inputting characters by combining predetermined characters, such as so-called ‘Cheon, Ji, In’.

In this method, since desired characters are generated by combining basic characters, the number of input buttons to which characters are assigned is reduced. However, since it is necessary to repeatedly press the input buttons until the desired characters are combined, the input time is longer as much.

In addition, there has been suggested a technique such as a keyboard capable of being carried with being rolled up or a virtual laser keyboard performing the input by projecting an image of the keyboard onto a flat part and then sensing the positions of fingers when a user takes action such as pressing keys of the keyboard on the image using its fingers.

However, this kind of input device has inconvenience that it needs to be carried. Also, the input can be performed only when the input device is placed on the flat part so that this input device is not suitable to be applied to a portable personal information terminal that can perform an input operation with being held by hand(s) while a user is moving.

The present invention will now be described more fully with reference to the accompanying drawings, in which embodiments of the present invention are shown.

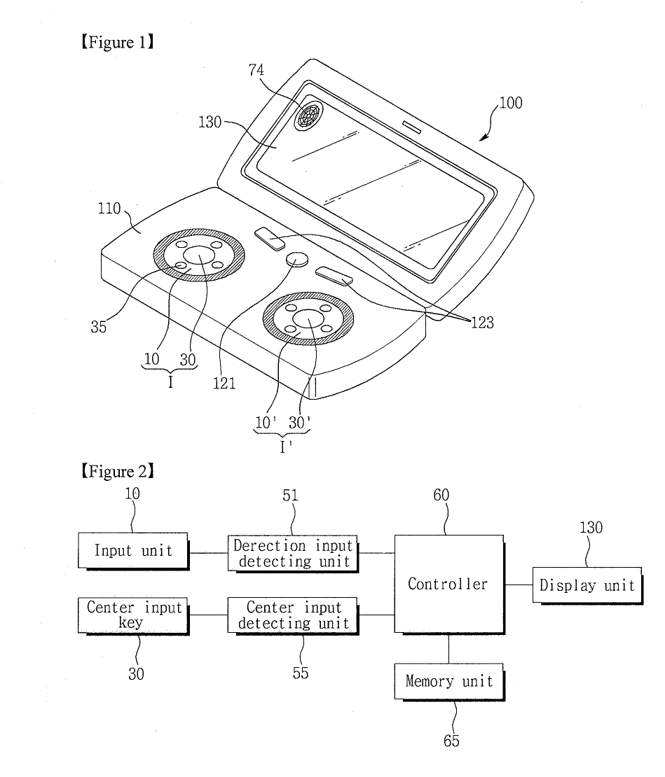

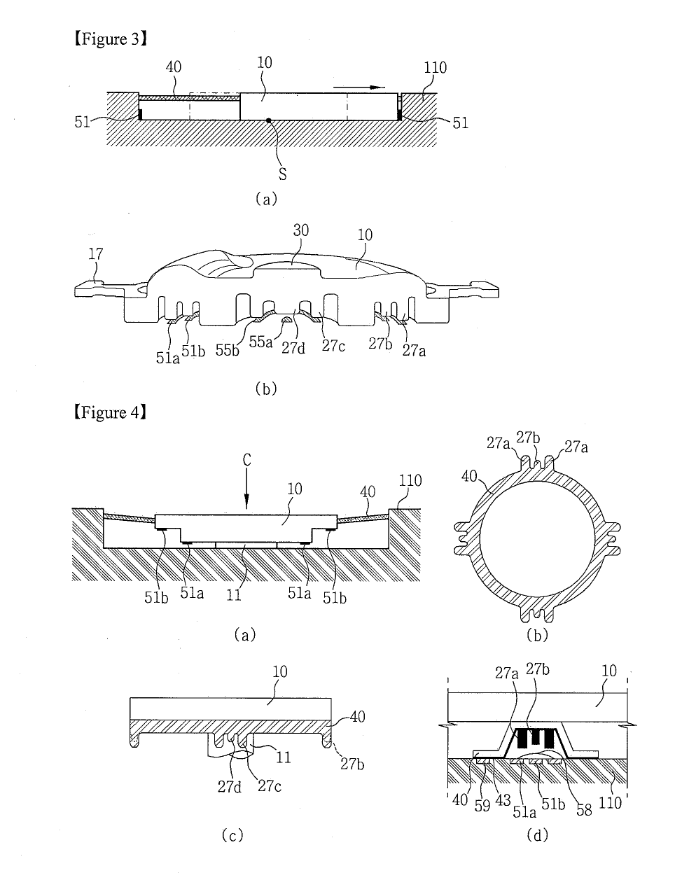

Referring to FIGS. 1, 2, and 7, a character input device 1 according to one embodiment of the present invention comprises a base 110 having an input region, two input units 10 and 10′ disposed in the input region, wherein each of the input units 10 and 10′ is disposed to perform direction inputs D that selects one of a plurality of direction instruction locations D₁, D₂, D₃, . . . that are radially spaced from each of reference locations S and S′ disposed in the input region in each of the direction instruction locations D₁, D₂, D₃, . . . in more than two multistage manner, a direction input detector 51 that detects whether the direction inputs D and a multistage input are performed, and a controller 60 that separately inputs a first character that is redundantly allocated to the direction instruction locations D₁, D₂, D₃, . . . according to the direction instruction locations D₁, D₂, D₃, . . . in which the direction inputs D are performed and the multistage input.

Hereinafter, a single reference numeral D or 10 is used to denote direction inputs D and D′ and the input units 10 and 10′ included in two input sets I and I.

### Direction Inputs D

The direction inputs D is an input of a character allocated to each of the direction instruction locations D₁, D₂, D₃, . . . by selecting one of the plurality of direction instruction locations D₁, D₂, D₃, . . . that are radially spaced in view of the reference location S from the reference location S using the input unit 10.

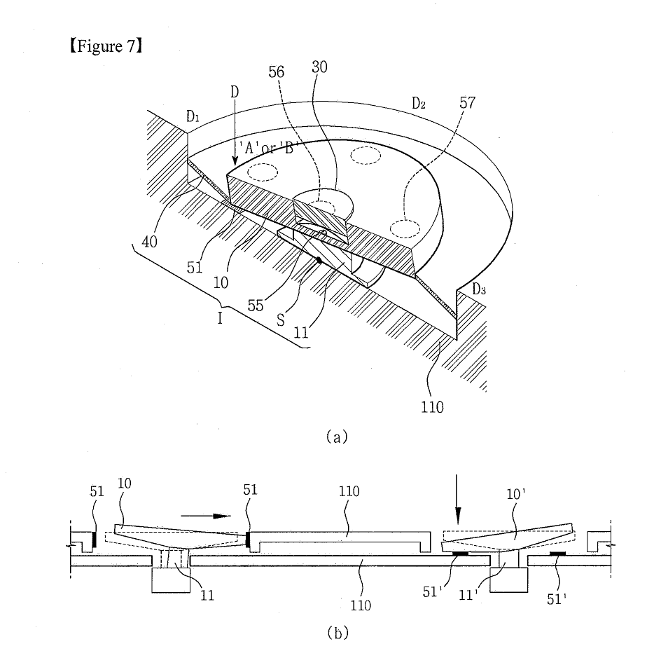

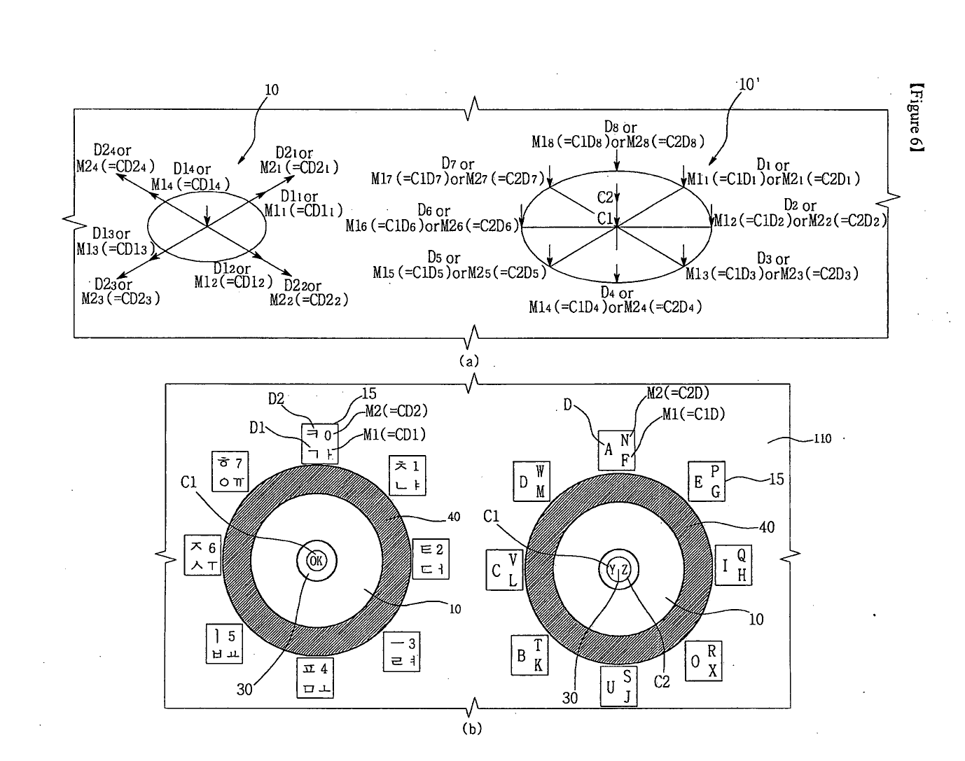

Referring to FIG. 7A, the plurality of direction instruction locations D₁, D₂, D₃, . . . are radially spaced apart from each other in view of the reference location S in the base 110.

The direction input detector 51 that detects movement of the input unit 10 is disposed in the base 110 that corresponds to each of the direction instruction locations D₁, D₂, D₃, . . . .

Therefore, if the input unit 10 moves from the reference location S to the predetermined direction instruction location D₁, the controller 60 extracts the first character allocated to the direction instruction location D₁ from the memory unit 65 and inputs the first character based on a detection signal of the direction input detector 51 that detects movement of the input unit 10.

The direction input detector 51 may have various types, for example, a pressure sensor, an optical sensor, or a contact sensor that corresponds to the input operation of the input unit 10.

Alternatively, the direction input detector 51 may be a touch pad, a touch screen, or a track point disposed in the overall input diameter.

Alternatively, the number of the direction instruction locations D₁, D₂, D₃, . . . may be various, i.e., four, eight, six or twelve direction instruction locations D₁, D₂, D₃, . . . .

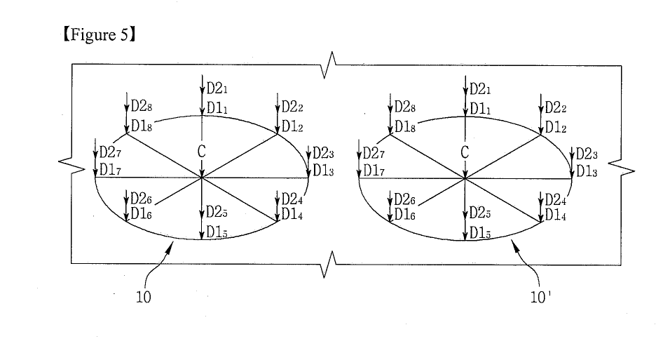

The direction inputs D may be performed using a variety of methods. For example, referring to FIG. 3A, the input unit 10 that is disposed in the reference location S slides (or horizontally moves) toward the predetermined direction instruction locations D₁, D₂, D₃, . . . and performs the direction inputs D.

The sliding or horizontal movement is not limited to a strict horizon with regard to the bottom surface of the base 110 but includes all possible angles and directions toward the direction instruction locations D₁, D₂, D₃, . . . from the reference location S.

Meanwhile, like a left input unit 10 shown in FIG. 7B, the direction inputs D may be performed when the input unit 10 inclines and moves toward one of the direction instruction locations D₁, D₂, D₃, . . . .

The inclined movement means that the overall of the input unit 10 obliquely moves toward a predetermined direction. Like a right input unit 10 shown in FIG. 7B, inclination that will be described later means that a part of the upper end of the input unit 10 inclines to a support unit 11.

Therefore, when the direction inputs D is performed by the inclined movement, besides a method of placing a finger on the upper end of the input unit 10, the input unit 10 may incline and move toward each of the direction instruction locations D₁, D₂, D₃, . . . by holding the input unit 10 with two or more fingers.

The direction inputs D may be performed by inclining the input unit 10 to one of the direction instruction locations D₁, D₂, D₃, . . . .

When the direction inputs D are performed through the inclined movement and inclination, the support 11, which supports the input unit 10 to enable the inclined movement or inclination, may be further included in the input unit 10 and the lower portion of the base 110.

In this case, the direction input detecting unit 51 may be the pressure sensor that identifies a multistage input according to the intensity of pressure applied by the input unit 10.

The direction inputs D may be performed by selecting one of pressing units 35 that corresponds to each of second direction instruction locations P₁, P₂, . . . .

The pressing units 35 have all types (excluding inclination or inclined movement of the input unit 10) that enable to independently select each of the direction instruction locations D₁, D₂, D₃, . . . in the upper end of the input unit 10.

For example, referring to FIG. 1, the pressing units 35 may be pressing buttons or pressing switches that are separately disposed to correspond to each of the direction instruction locations D₁, D₂, D₃, . . . .

Alternatively, referring to FIG. 3B, the pressing units 35 may be pressing locations in which the direction input detecting unit 51 is disposed in the upper end or inside the input unit 10 to correspond to each of the direction instruction locations D₁, D₂, D₃, . . . .

In this case, contact units 27a and 27b that are protruded downward are disposed in the lower portion of the input unit 10. Therefore, if the upper end portion of the input unit 10 is pressed, the contact units 27a and 27b goes down and contact the direction input detecting units 51a and 51b to perform the direction inputs D.

The contact units 27a and 27b having a different length by the number of multistage inputs sequentially contact the direction input detecting units 51a and 51b.

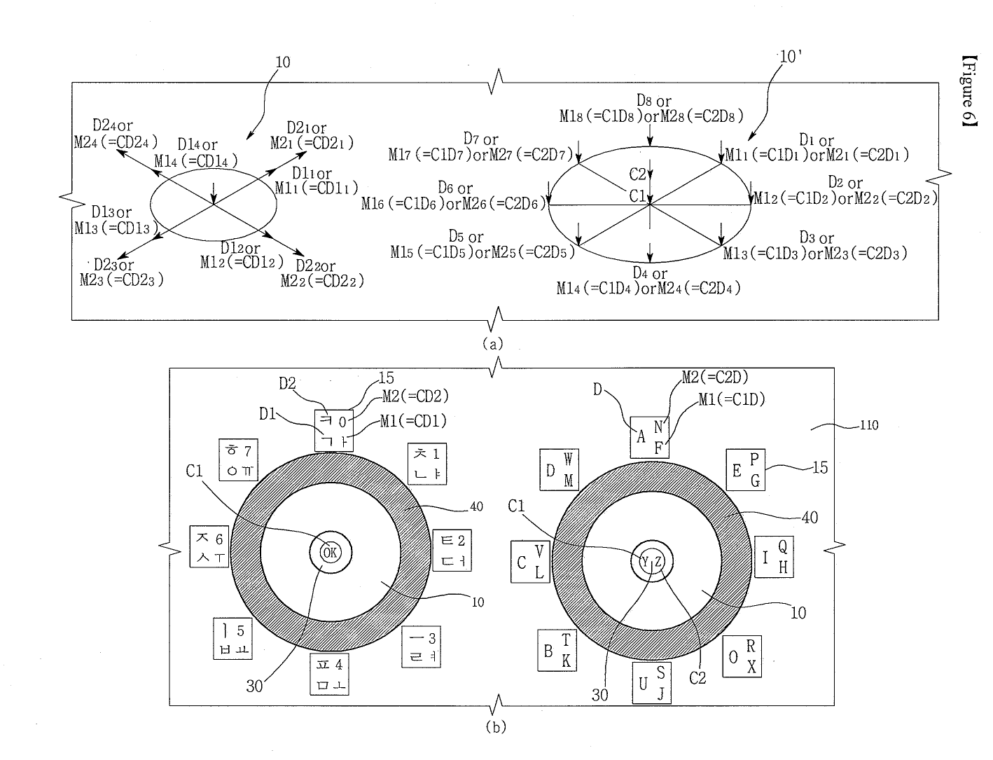

Referring to FIG. 4D, an elastic member 40 may be disposed to form a pressing space between the input unit 10 and the base 110. The direction input detecting unit 51 may be disposed in the lower portion of the elastic member 40.

At this time, the contact units 27a and 27b that are protruded to have a different length are disposed toward the direction input detecting unit 51a and 51b in the inner surface of the elastic member 40.

A conductive member 43 is disposed between the contact units 27a and 27b and the elastic member 40. One end of the conductive member 43 is connected to a ground terminal 59 and another end thereof is connected to the contact units 27a and 27b so that a detection signal is transferred to the controller 60 through the contact units 27a and 27b.

Thus, if the direction input D1 of one step is performed, the exterior side of the contact unit 27a contacts a metal dome 58 and generates a direction input signal of one step. At this time, the contact unit 27a contacts edges of the metal dome 58 so that the metal dome 58 maintains its original shape.

Thereafter, if the direction input D2 of two steps is performed, the inner side of the contact unit 27b goes down to transform the metal dome 58, contacts the direction input detecting unit 51b, and generates a direction input signal of two steps.

In this regard, since the transformation of the metal dome 58 may cause a click sense, it is advantageous that a user can easily identify an input of one step and an input of two steps.

In the previous embodiments, the direction inputs D can be performed while moving in a semi-diameter direction and in a circumferential direction in view of the reference location S.

For example, when the direction inputs D are performed through sliding, the input unit 10 does not return to the reference location S after moving to the predetermined direction instruction locations D₁, D₂, D₃, . . . from the reference location S but moves in the circumferential direction and may move to another direction instruction locations D₁, D₂, D₃, . . . .

Alternatively, when the direction inputs D are performed by inclined movement or inclination, the input unit 10 may incline to the predetermined direction instruction locations D₁, D₂, D₃, . . . rotate in the circumferential direction, and move to another direction instruction locations D₁, D₂, D₃, . . . .

Meanwhile, the direction inputs D may be a multistage input of two or more steps according to a difference between movement distances or strength of a movement pressure.

For example, when the direction inputs D are performed through the horizontal movement (or sliding) of the input unit 10, the direction input detecting unit 51 and 51b of two or more steps are sequentially disposed on a movement path of the input unit 10 from the reference location S to each of the direction instruction locations D₁, D₂, D₃, . . . .

Alternatively, when the direction inputs D are performed by inclination or inclined movement of the input unit 10, one or more optical sensors that detect the inclination of the input unit 10 or the support unit 11 may be disposed according to an inclined angle.

Alternatively, referring to FIG. 4A, when the direction inputs D are performed with the inclination of two steps, for example, a step may be formed according to the connection portion and the lower portion of the input unit 10.

Therefore, the lower portion of the direction input detecting unit 51a contacts the base 110 by the inclination of one step, and the upper portion of the direction input detecting unit 52b contacts the base 110 by inclination of two steps.

Alternatively, referring to FIG. 4B or 4C, the first contact unit 27a or the second contact unit 27b having a different protrusion length is disposed in the elastic member 40 or the input unit 10 disposed in the connection portion or the lower portion of the input unit 10 to correspond to each of the direction instruction locations D₁, D₂, D₃, . . . .

FIG. 4B is a plan view of the elastic member 40 disposed in the lower portion of the input unit 10 when the input unit 10 slidingly moves. FIG. 4C is a side cross-sectional view of the input unit 10 and the elastic member 40 when the input unit 10 inclines.

In this case, the relatively long first contact unit 27a first contacts the base 110 and then the second contact unit 27b contacts the base 110 according to the movement degree of the input unit 10. The contact units 27a and 27b may be formed of an elastic conductive member.

Alternatively, when the pressing units 35 are disposed in the input unit 10, the direction input detecting unit 51 that is the pressure sensor may be identified as a multistage according to the strength of pressing pressure applied to the pressing units 35.

Alternatively, when touch detecting units 56 and 57 that detect contact or proximity of a finger are disposed in the input unit 10, the touch detecting units 56 and 57 may be identified as a multistage by a touch input or the direction inputs D.

Alternatively, the direction inputs D may be divided into a multistage according to a period of time taken to perform each of the direction inputs D. For example, even when sliding distances of the input unit 10 or pressing distances of the pressing units 35 are the same as each other, if the movement state of the input unit 10 maintains 2 seconds, the direction inputs D may be processed as the direction input D1 of one step, and if the movement state of the input unit 10 exceeds 2 seconds, the direction inputs D may be processed as the direction input D2 of two steps.

The method of detecting an input of two steps performed by the direction input detecting unit 51 is not limited thereto but may have a variety of modifications.

An example of a signal processing method used to input a multistage in the controller 60 will now be described.

For example, when an input of two steps is performed with regard to the direction input D2 of two steps, since an input of one step is first performed, the controller 60 can standby whether the direction input D2 of two steps is performed within a predetermined standby period of time after the direction input D1 of one step is performed, and determine whether the input of two steps is performed.

The controller 60 may process the input of one step without waiting the standby period of time if the direction input D1 of one step is performed, and cancel the input of one step if the input of two steps is performed within the standby period of time and changes the input of one step to the input of two steps. In this case, an input delay can be prevented during the standby period of time.

Alternatively, instead of whether the predetermined standby period of time elapses, whether to change the input of one step can be determined according to whether the input of one step is off.

For example, the direction inputs D return to the reference location S after it is performed or a final input is determined when an input detection signal of one step is off.

By doing so, an input is processed immediately when the first input is performed, and the input is determined if the input of one step is off. However, under the state when the input of one step is performed irrespective of a standby period of time, if the input of one step is not off but is continuously performed, the input of one step is canceled and the input of two steps proceeds.

The signal processing method described above cancels the input of one step when the input of one step is processed due to a wrong input when the input of two steps is performed, further proceeds with the input of two steps without performing the input of two steps under the state when the input of one step is processed, and changes the input of one step into the input of two steps, thereby more quickly processing the input.

As described above, when the input is processed immediately if a predetermined input signal is detected, and the final input is determined just when the input is off, if a wrong input is performed when the direction inputs D are performed, the wrong input is corrected to a desired input before the final input is determined without deleting the processed input content and performing an input again, thereby making the input easier.

Alternatively, when the direction input detecting unit 51 is the pressure sensor, the input of one step and the input of two steps may be determined using the maximum input value that occurs during the standby period of time.

Alternatively, the input of one step and the input of two steps may be identified based on detection time taken to detect the input unit by the direction input detecting unit 51.

For example, if the detection time is less than 0.5 second, the input of one step is performed, and if the detection time exceeds 0.5 second, the input of two steps is performed.

In connection with the pressure sensor, as described above, the input is processed immediately if the input of one step is performed, and the input is determined if the input of one step is off, so that if a detection value corresponding to the input of two steps is additionally detected before the input of one step is off, the input of one step may be canceled and the input of two steps may be determined.

With regard to the signal processed by the controller 60 regarding the multistage input mentioned above, a center input C and a center combination input M in addition to the direction inputs D can be applied in the same manner.

As described above, when the direction inputs D constitute multiple steps, the number of characters allocated by the number of multiple steps (or the number of characters that can be input through the direction inputs D) increases.

Meanwhile, when the direction inputs D are performed, the input unit 10 moves to a center region of two of the direction instruction locations D₁, D₂, D₃, . . . and the two direction input detecting unit 51 simultaneously detects the movement of the input unit 10, interference between input signals may occur.

In this case, the controller 60 can effectively determine an initially generated detection signal among a plurality of detection signals.

In more detail, an initially input signal may be effectively input, and other input signals may be disregarded before the initial signal is off (for example, before the direction inputs D are performed and returns to the reference location S) or within a predetermined period of time.

As another method, all signal values that can be detected through interference may be processed in database. For example, if one, two, or three detection signals are generated at a predetermined location in the direction input detecting unit 51, when an input value of each case is processed in database and a predetermined signal is detected, an input value is output in corresponding database.

When the direction input detecting unit 51 is the pressure sensor, a detection location that is regarded as the maximum input value may be effectively determined.

Meanwhile, referring to FIG. 7A, the touch detecting unit 57 that detects proximity or contact of a finger may be disposed in the upper end of the input unit 10 or each of the pressing units 35 corresponding to each of the direction instruction locations D₁, D₂, D₃, . . . .

In this case, since a touch input can be performed in addition to each direction input, input quantity can increase by the touch input.

### Center Input C

The center input C selects a center input key 30 disposed in the center of the input unit 10 besides the direction inputs D, or performs an input such as a character, a symbol, a number, or a mode change that is allocated when the input unit 10 itself goes up and down.

For example, referring to FIG. 1, the center input C may be performed by the center input key 30 that can select the center of the input unit 10 and a center input detecting unit 55 (referring to FIG. 7A) that detects the selection of the center input key 30.

Alternatively, the center input C may be performed when the input unit 10 wholly up and down moves with regard to the base 110, and performed by the center input detecting unit 55 that is disposed in one of the input unit 10 and the base 110 and detects up and down movement of the input unit 10.

Any one or both of two types of the center input C may be performed.

Meanwhile, with regard to the center input C, a multistage input of more than two steps can be possible according to a pressing distance or pressing strength of the center input key 30 or a distance of the input unit 10 itself that moves up and down.

For example, referring to FIG. 3B, contact units 27c and 27d that are protruded downward and have a different length are disposed in the lower portion of the center input key 30, so that the contact units 27c and 27d may go down when the center input key 30 is pressed, and sequentially contact the center input detecting units 55a and 55b.

Meanwhile, the touch detecting unit 56 that detects proximity or contact of the center input key 30 is disposed, so that a touch input that inputs another character that is redundantly allocated to the center input key 30 can be performed.

In this case, the controller 60 can discriminate and perform the direction inputs D (in particular, selection of the pressing units 35) by putting a finger on the input unit 10 and sole selection of each of the pressing units 35.

For example, referring to FIG. 7A, when the controller 60 contacts the finger to the center input key 30, inclines the finger when the touch detecting unit 56 generates a center touch detection signal, and selects the pressing units 35 in the direction of D₂, a character A is input, and when the pressing units 35 are selected without putting the finger on the input unit 10, a character B is input.

Alternatively, when the touch detecting unit 56 detects contact of the finger more than a predetermined period of time, the controller 60 may disregard the detection result obtained by the touch detecting unit 57 so that the touch input cannot be performed.

### Two Sets

The character input device 1 comprises the base 110 including two input sets I and I′.

FIGS. 1 and 7 are perspective views of two left and right input sets I and I′ disposed in the base 110 of a portable mobile communication terminal 100 for explaining an input operation.

Each of the input sets I and I′ comprises one or more among the input units 10 and 10′ the center input keys 30 and 30′ the direction input detecting units 51 and 51′ and the center input detecting units 55 and 55′.

In this case, the two input units 10 and 10′ may have the same constitution or a different constitution.

In more detail, referring to FIG. 7B, the left input unit 10 may be disposed to perform the direction inputs D by the inclined movement, and the right input unit 10′ may be disposed to perform the direction inputs D by the inclination.

Alternatively, any one of the two input units 10 and 10′ may be disposed to perform more than two steps of multistage input, and as shown in FIG. 5, both of the two input units 10 and 10′ may be disposed to perform the multistage input.

Or, the center input keys 30 and 30′ may be also disposed in a side or both sides.

Likewise, the center combination input M may be also performed through any one of the two input units 10 and 10′ and through both of the two input units 10 and 10′.

Meanwhile, in each case mentioned above, the two input units 10 and 10′ may have a different number of the direction instruction locations D₁, D₂, D₃, . . . .

Therefore, the number of characters that can be input through the two input sets I and I′ can be freely controlled through the constitution of each of the input sets I and I′.

Meanwhile, as described above, when the two input sets I and I′ constitute the direction inputs D in a multistage manner, since the two input sets I and I′ has a sufficient input quantity, arrangement of characters, functions, symbols, or the like can have a variety of modifications.

For example, when characters are arranged, a consonant character may be disposed in any one of the two input units 10 and 10′ and a vowel character may be disposed in another one.

Alternatively, the consonant character may be disposed in the input of one step, and the vowel character may be disposed in the input of two steps.

Alternatively, the input unit 10 may input a character, and the input unit 10′ may perform the movement of a mouse pointer/game character, a function command, a mode change, a direction instruction input, or an input of a number or symbol.

In this case, a simultaneous use of the character input and the mouse can result in an effect of simultaneously using a keyboard and the mouse in a desktop computer, so that a small-sized terminal can perform a game requiring various jobs and a complicated operation of using the keyboard and the mouse.

Meanwhile, in the mouse or a game mode, any one of the two input units 10 and 10′ may perform the movement of the pointer or the game character, and another one may perform an operation of the pointer or a variety of operation commands of the game character.

In particular, the left input unit 10 may be disposed to perform the direction inputs D by the sliding, and the right input unit 10′ may be disposed to perform the direction inputs D by the inclination or using the pressing units 35.

### Center Combination Input M

The center combination input M is that the center input C is performed simultaneously with the direction inputs D.

For example, referring to FIG. 6A, when the direction inputs D is performed, while the center input key 30 is pressed, the input unit 10 slides toward the predetermined direction instruction locations D₁, D₂, D₃, . . . or while the center input key 30 is pressed, the input unit 10 inclines to the predetermined direction instruction locations D₁, D₂, D₃ . . . .

In more detail, referring to FIG. 6A, in a process of moving the input unit 10 to a predetermined direction instruction location D1₁, if the input unit 10 moves under the state when the center input C is performed, the direction combination input CD1₁ is performed, while a direction input D1₁ is performed if the input unit 10 moves by not performing the center input C.

The center combination input CD can be applied when any one of the direction inputs D and the center input C is a multistage input of two or more steps.

For example, referring to the right input unit 10′ of FIG. 5, when the direction inputs D of one step is performed and the center inputs C1 and C2 of two steps are performed, a center combination input C1D₁ of one step in the combination of a direction input D₁ and the center input C1 of one step, and a center combination input C2D₁ of two steps in the combination of the direction input D₁ and the center input C2 of two steps are possible.

FIG. 6B illustrates the two input sets I and I′ to which the direction inputs D, the center input C, and the center combination input M are applied.

Referring to FIG. 6B, the left input unit 10 performs the direction inputs D of two steps and the center input C of one step.

In this case, the direction inputs D1 and D2 and the center combination input M make four characters allocated to each of the direction instruction locations D₁, D₂, D₃, . . . each corresponding to 1) D1: the direction inputs D of one step, 2) D2: the direction inputs D of two steps, 3) M1: a combination of the direction input D1 of one step and the center input C, and 4) a combination of the direction input D2 of two steps and the center input C.

A character display unit 15 that displays a character that is input by each of the direction inputs D and the center combination input M corresponding to each of the direction instruction locations D₁, . . . , D₈ is disposed in one side of the base 110.

The character display unit 15 may have various types, for example, an LCD window that can change displayed content.

In this case, when a plurality of character sets are disposed in each of the direction instruction locations D₁ . . . , D₈, a set of characters that are selected by a user's input operation can be changed and displayed.

A character displayed at the left lower end of the character display unit 15 is input by the direction input D1 of one step. A character displayed at the left upper end of the character display unit 15 is input by the direction input D2 of two steps. A character displayed in the right lower end of the character display unit 15 is input by the center combination input M1 that is performed via a combination of the direction input D1 of one step and the center input C.

Therefore, if the input unit 10 performs the direction input D1 of one step toward 12 o'clock, a character ‘ [symbol] ’ is input, if the input unit 10 performs the direction input D2 of two steps, a character ‘ [symbol] ’ is input, and if the input unit 10 combines the direction input D1 of one step and the center input C, and a character ‘ [symbol] ’ M1 is input.

And, if the input unit 10 combines the direction input D2 of two step and the center input C, a number ‘0’ is input. In this case, if the center input C is performed independently, a character ‘ok’ is input.

In one embodiment, when 8 direction instruction locations D₁, . . . D₈ are disposed, the character input device 1 can input 33 characters including 16 direction inputs D of one step and two steps, 1 center input c, and 16 center combination input M.

The input unit 10′ that is disposed in the right side shown in FIG. 6B performs the direction inputs D of one step and the center input C of two steps.

In this case, the direction inputs D and the center combination input M make it possible to perform three inputs each corresponding to 1) D1: the direction inputs D of one step, 2) M1: a combination of the direction input D1 of one step and the center input C1 of one step, and 3) a combination of the direction input D1 of one step and the center input C2 of two steps.

Meanwhile, the center input C can solely be performed as Y by one step, and as Z by two steps.

The center combination input M described above can have various character arrangements. For example, a vowel character may be arranged in any one of the direction inputs D and the center combination input M, and a consonant character may be arranged in the other one.

In this case, the vowel character is arranged, and various function commands and mode change function may be disposed in a location except the vowel character.

Alternatively, not a character input but various function commands such as enter, space, cancel or the like, and a mode change to Korean characters, alphabets, numbers, symbols or the like may be performed through the center combination input M.

### Embodiment

Hereinafter, embodiments of the character input device 1 will be described.

First, the two input units 10 and 10′ are disposed in the base 110.

The direction inputs D1 and D2 of multi steps may be performed by all inclined movements. The center input keys 30 and 30′ may be disposed in each of the input units 10 and 10′.

Alternatively, referring to FIG. 3A, each of the input units 10 and 10′ may perform the direction inputs D1 and D2 of multiple steps by all sliding, and may perform the center input C.

In both cases described above, each of the input units 10 and 10′ may be disposed to perform the center combination input M.

Or, without the center input C, each of the input units 10 and 10′ may perform the direction inputs D1 and D2 of multiple stages according to the selection of the pressing units 35 or perform the direction inputs D1 and D2 of multiple steps by the inclination.

In this case, only the center input C or even the center combination input M may be added to each of the input units 10 and 10′.

Or, one input unit 10 may perform the direction inputs D by sliding, and another input unit 10′ may perform the direction inputs D through the pressing units 35. In this case, as occasion demands, one or more input units 10 and 10′ may perform an input of multiple steps.

### Miscellaneous

The input unit 10 may have various shapes.

For example, referring to FIG. 7A, the input unit 10 may have a circular shape or a polygonal shape.

The input unit 10 may have a variety of size, and have the size to perform the direction inputs D within a movement diameter of a finger or by putting the finger thereon.

The input unit 10 may have a function of automatically returning to the reference location S after performing the direction inputs D.

The return function may be realized using various methods. For example, referring to FIG. 3A, the elastic member 40 is disposed between the input unit 10 and the base 110 so that the input unit 10 can return to the reference location S after performing the direction inputs D.

A slide preventing unit (not shown) that prevents a finger contacting the input unit 10 from sliding when the input unit 10 performs the direction inputs D may be disposed on the upper surface of the input unit 10.

The slide preventing unit may have a variety of types, for example, an unevenness on the upper surface of the input unit 10, and a concave groove in the center of the input unit 10.

Alternatively, the input unit 10 may form a protrusion unit 17 (referring to FIG. 3B) in the upper end at one side thereof in order to easily hold or operate a finger when the input unit 10 performs the direction inputs D, and may further comprise a projection unit in the center of the upper surface thereof in order to facilitate the operation of the input unit 10 when the input unit 10 performs the direction inputs D.

In one embodiment, the projection unit facilitates an input when the character input device 1 that is placed on a table or ground is used, and an index finger or a middle finger and a thumb as well is used. For example, the projection unit may have a ring shape or a convex or concave shape.

More than one of a mode change key 121 for changing an input mode and a function key 123 for inputting a function command such as enter, delete, cursor, or the like may be disposed in one side of the base. The mode change key 121 or the function key 123 may use a touch detecting method.

Meanwhile, a display unit 103 for displaying an input command extracted by the controller 60 may be disposed in another side of the base.

As shown in FIG. 1, a keyboard display unit 74 for displaying input content according to a user' input operation or a character allocated in a selected input mode may be disposed in the display unit 130.

The display unit 130 may be detachably formed in the base 110. In this case, the base 110 further comprises a transmitting/receiving unit that can be connected to an external device using one or more of wired/wireless methods. The character input device 1 may be used as a remote controller for remotely controlling a computer or television.

The direction inputs D or any one of the direction inputs D may be used to change channels or adjust volume. Or, the direction inputs D may be used to input a number or change various modes. The direction inputs D solely may adjust channels or volume.

Meanwhile, a reference location detecting unit (not shown) that detects that the input unit 10 is disposed in the reference location S may be further included in the reference location S. The reference location detecting unit that detects that the input unit 10 is disposed in the reference location S so that a detection signal of the reference location detecting unit can be used as a reset signal for inputting a character.

According to at least one embodiment of the present invention, the character input device having the construction described above includes two sets of input units that input more than one phoneme at an operation, thereby doubling input quantity and simultaneously inputting a character quickly and accurately.

While the present invention has been particularly shown and described with reference to exemplary embodiments thereof, it will be understood by those of ordinary skill in the art that various changes in form and detail may be made therein without departing from the spirit and scope of the present invention as defined by the following claims.

1. A character input device comprising;
a base including an input region;
two input units disposed in the input region, wherein each of the input units is disposed to perform direction inputs of more than two steps that selects any one of a plurality of direction instruction locations that are radially spaced apart from each other from each of reference locations within the input region in each of the direction instruction locations;
a direction input detecting unit configured to detect whether the direction inputs and a multiple input are performed; and
a controller configured to discriminate and input a first character that is redundantly allocated at the corresponding direction instruction location according to the direction instruction location in which the direction inputs are performed and whether the multiple input is performed.

2. The character input device of claim 1, wherein the direction inputs are performed by the input unit by selecting any one of pressing units disposed to correspond to each of the direction instruction locations, and are discriminated to be multiple steps according to pressing distances or pressing strength of the pressing units.

3. The character input device of claim 1, wherein the direction inputs are performed when the input unit inclines to any one of the direction instruction locations, and are discriminated to be multiple steps according to an inclination angle.

4. The character input device of claim 1, wherein the direction inputs are performed when the input unit inclines and moves to any one of the direction instruction locations, and are discriminated to be multiple steps according to an angle of an inclined movement.

5. The character input device of claim 1, wherein the direction inputs are performed when the input unit slides to any one of the direction instruction locations, and are discriminated to be multiple steps according to a sliding distance.

6. The character input device of claim 1, wherein a vowel character is input to any one of the direction inputs of multiple steps.

7. The character input device of claim 1, further comprising: a center input key disposed in the center of the input unit, wherein a center input is performed by a pressing operation.

8. The character input device of claim 7, wherein the center input is performed as a multiple step input of more than two steps according to a pressing distance of the center input key.

9. The character input device of claim 7, wherein a center combination input can be performed in which the center input and the direction inputs are simultaneously made,
wherein, when the center combination input is performed, the controller extracts and inputs a second character allocated in each of the direction instruction locations from a memory unit.

10. The character input device of claim 1, wherein a touch detecting unit that detects proximity or contact of a finger is disposed in one or more of the upper end of the input unit, the center input key and the pressing units corresponding to the direction instruction locations, thereby allowing a touch input in addition to the direction input and the center input.

11. The character input device of claim 10, wherein the controller discriminates when a touch detection signal by a touch of the finger to the center input key and a direction input detection signal by the pressing of the pressing units are simultaneously received, and when only the direction input detection signal is received, and inputs a different character.

12. (canceled)

13. The character input device of claim 1, further comprising: a character display unit disposed in any one of the base and the input unit corresponding to each of the direction instructions locations and displaying a character allocated in the direction inputs or the center combination input in each direction instruction location,
wherein when a plurality of character sets are disposed in each direction instruction location, the character display unit displays a character input set that is selected according to a user's input operation.

14. The character input device of claim 1, wherein the direction inputs that are performed in the two input units have different types.

15-22. (canceled)

23. A character input device comprising;
a base including an input region;
two input units disposed in the input region, wherein each of the input units is disposed to perform direction inputs of more than two steps that selects any one of a plurality of direction instruction locations that are radially spaced apart from each other from each of reference locations within the input region in each of the direction instruction locations;
means for detecting whether the direction inputs and a multiple input are performed; and
means for discriminating and inputting a first character that is redundantly allocated at the corresponding direction instruction location according to the direction instruction location in which the direction inputs are performed and whether the multiple input is performed.
